(19) United States
(12) Patent Application Publication
(10) Pub. No.: US 2025/0237280 A1
(43) Pub. Date: Jul. 24, 2025

(54) TUBULAR VIBRATION-DAMPING DEVICE FOR MOTOR MOUNT

(71) Applicant: SUMITOMO RIKO COMPANY LIMITED, Komaki-shi (JP)

(72) Inventor: Toyoshi SETOYAMA, Komaki-shi (JP)

(73) Assignee: SUMITOMO RIKO COMPANY LIMITED, Komaki-shi (JP)

(21) Appl. No.: 18/956,341

(22) Filed: Nov. 22, 2024

(30) Foreign Application Priority Data
Jan. 18, 2024 (JP) 2024-006065

(51) Int. Cl. F16F 1/38; B60K 1/00

(52) U.S. Cl. CPC F16F 1/3835; B60K 1/00

(57) ABSTRACT

A tubular vibration-damping device for a motor mount including: an inner shaft member; an outer tube member; and a plurality of rubber legs extending between surfaces of the inner shaft member and the outer tube member facing in a radial direction and connecting them, wherein the plurality of rubber legs include four rubber legs which mutually separate wider apart in a circumferential direction as they go to a periphery in an up-down direction and a left-right direction, for the four rubber legs, a difference in cross-sectional areas each in a leg transverse cross section orthogonal to a length direction, which is a connection direction of the inner shaft member and the outer tube member, is 20% or less, and the four rubber legs have mutually different shapes and resonant states against a vibration input in the up-down direction.

### INCORPORATED BY REFERENCE

The disclosure of Japanese Patent Application No. 2024-006065 filed on Jan. 18, 2024 including the specification, drawings and abstract is incorporated herein by reference in its entirety.

### BACKGROUND ART

### 1. Technical Field

The present disclosure relates to a tubular vibration-damping device for a motor mount, used as a motor mount for linking an electric motor to a vehicle body in a vibration-damping manner, in an electrification vehicle such as an electric vehicle (BEV) and a hybrid car.

### 2. Description of the Related Art

With the recent shift to electrification of vehicles, development of a motor mount that provides vibration-damping linkage of an electric motor to a vehicle body has been promoted. For example, as disclosed in FIG. 5, etc. of German Patent Publication No. DE102018221375, a tubular vibration-damping device wherein an inner shaft member and an outer tube member are interconnected by a plurality of rubber legs extending in the radial direction is used as the motor mount.

### SUMMARY

By the way, in a motor mount that supports an electric motor which has lower vibration than an internal combustion engine in a vibration-damping manner, deterioration of vibration state in a high-frequency range caused by surging of the rubber legs can easily become a problem. In particular, as shown in FIG. 5 of DE102018221375, when the motor mount has the plurality of rubber legs of substantially the same shape and size, the resonance frequencies of the plurality of rubber legs are almost the same as each other, which may cause significant deterioration in the vibration state at a specific frequency.

In DE102018221375, mass protrusions are formed protruding from the rubber legs, and the mass damper action, etc. of the mass protrusions prevents the adverse effect on the vibration state caused by the surging of the rubber legs. However, when the rubber legs are provided with the mass protrusions, the strain is concentrated at the base portions of the mass protrusions when the rubber legs are deformed during a vibration input, which can easily cause damage to the mass protrusions and rubber legs.

It is therefore one object of the present disclosure to provide a tubular vibration-damping device for a motor mount of novel structure which is able to prevent vibration state from deteriorating significantly at a specific frequency due to surging, while ensuring the durability of the rubber legs.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides a tubular vibration-damping device for a motor mount comprising: an inner shaft member; an outer tube member; and a plurality of rubber legs extending between a surface of the inner shaft member and a surface of the outer tube member which face each other in a radial direction and connecting them, wherein the plurality of rubber legs include four rubber legs which mutually separate wider apart in a circumferential direction as they go to a periphery in an up-down direction and in a left-right direction, for the four rubber legs, a difference in cross-sectional areas each in a leg transverse cross section orthogonal to a length direction, which is a connection direction of the inner shaft member and the outer tube member, is 20% or less, and the four rubber legs have mutually different shapes and resonant states of the four rubber legs against a vibration input in the up-down direction are mutually different.

With the tubular vibration-damping device for the motor mount structured according to the present preferred embodiment, the difference in the cross-sectional areas of the four rubber legs in the leg transverse cross section is 20% or less. By so doing, the shapes of the four rubber legs can be made different from each other while keeping the volumes of the four rubber legs similar to each other. This makes it possible to keep the rubber volume of each rubber leg as well in order to avoid deterioration in durability, etc., while suppressing deterioration of spring characteristics at a specific frequency by differentiating the resonance frequencies of the four rubber legs, for example.

A second preferred embodiment provides the tubular vibration-damping device for the motor mount according to the first preferred embodiment, wherein two upper rubber legs of the four rubber legs have a same length dimension in the connection direction of the inner shaft member and the outer tube member, two lower rubber legs of the four rubber legs have a same length dimension in the connection direction of the inner shaft member and the outer tube member, and the length dimension of the two upper rubber legs in the connection direction of the inner shaft member and the outer tube member is different from that of the two lower rubber legs.

With the tubular vibration-damping device for the motor mount structured according to the present preferred embodiment, the lengths of the two upper rubber legs are equalized, while the lengths of the two lower rubber legs are equalized, and the lengths of the upper rubber legs are differentiated from the lengths of the lower rubber legs. This makes it possible, for example, to set the springs on both upper and lower sides as appropriate, considering the distributed load of the motor unit and the load input during acceleration/deceleration, etc. In addition, the shapes of the rubber legs on the upper and lower sides can be made different from each other by the difference in the lengths of the rubber legs on the upper and lower sides.

A third preferred embodiment provides the tubular vibration-damping device for the motor mount according to the first or second preferred embodiment, wherein two upper rubber legs of the four rubber legs have a first common cross-sectional area part with a same cross-sectional area in the leg transverse cross section orthogonal to the length direction, which is the connection direction of the inner shaft member and the outer tube member, and two lower rubber legs of the four rubber legs have a second common cross-sectional area part with a same cross-sectional area in the leg transverse cross section.

With the tubular vibration-damping device for the motor mount structured according to the present preferred embodiment, the shape difference between the upper rubber legs can be suppressed and the shape difference between the lower rubber legs can be suppressed, so that the springs of the left and right rubber legs for the inner shaft member can be set in good balance. Therefore, for example, unintended swinging caused by unbalance between the left and right springs or the like is suppressed during a vibration input in the up-down direction, and adverse effects on the vibration state are prevented.

A fourth preferred embodiment provides the tubular vibration-damping device for the motor mount according to any one of the first to third preferred embodiments, wherein an upper left rubber leg and a lower right rubber leg of the four rubber legs have a same shape in the leg transverse cross section, an upper right rubber leg and a lower left rubber leg of the four rubber legs have a same shape in the leg transverse cross section, and the shape in the leg transverse cross section of the upper left rubber leg and the lower right rubber leg is different from that of the upper right rubber leg and the lower left rubber leg.

With the tubular vibration-damping device for the motor mount structured according to the present preferred embodiment, the cross-sectional shapes of the rubber legs arranged in a diagonally opposite direction are the same as each other, so that unintended relative displacement such as swinging between the inner shaft member and outer tube member during a vibration input is prevented and the vibration state is more easily stabilized, for example.

According to the present disclosure, it is possible to prevent the vibration state from deteriorating significantly at a certain frequency due to surging, while ensuring the durability of the rubber legs in the tubular vibration-damping device for the motor mount.

### BRIEF DESCRIPTION OF THE DRAWINGS

The foregoing and/or other objects, features and advantages of the disclosure will become more apparent from the following description of a practical embodiment with reference to the accompanying drawings in which like reference numerals designate like elements and wherein:

FIG. 1 is a front view of a tubular vibration-damping device for a motor mount as a first practical embodiment of the present disclosure;

FIG. 2 is a cross sectional view taken along line 2-2 of FIG. 1;

FIG. 3 is a cross sectional view taken along line 3-3 of FIG. 1;

FIG. 4 is a cross sectional view taken along line 4-4 of FIG. 1;

FIG. 5 is a cross sectional view taken along line 5-5 of FIG. 1;

FIG. 6 is a cross sectional view taken along line 6-6 of FIG. 1;

FIG. 7 is a cross sectional view taken along line 7-7 of FIG. 1;

FIG. 8 is a cross sectional view taken along line 8-8 of FIG. 1;

FIG. 9 is a cross sectional view taken along line 9-9 of FIG. 1;

FIG. 10 is a cross sectional view taken along line 10-10 of FIG. 1; and

FIG. 11 is a graph showing vibration-damping characteristics of the tubular vibration-damping device for the motor mount shown in FIG. 1.

### DETAILED DESCRIPTION

There will be described a practical embodiment of the present disclosure with reference to the drawings.

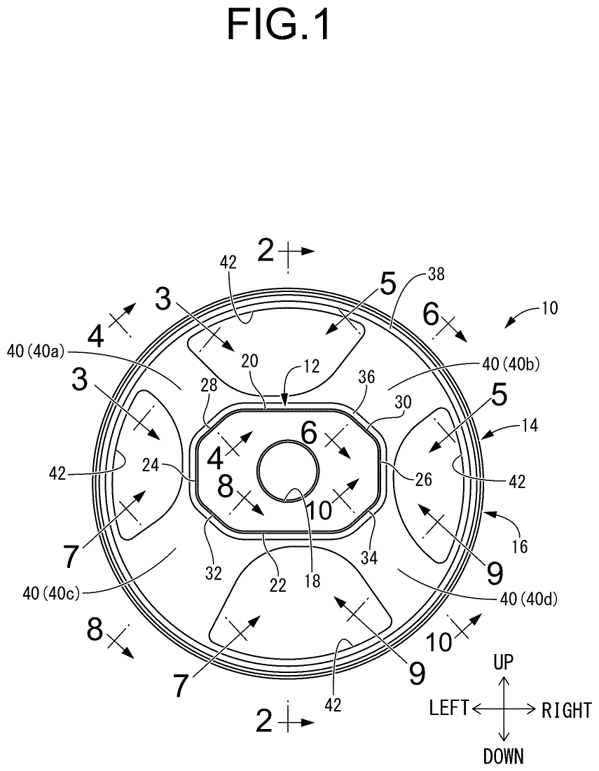

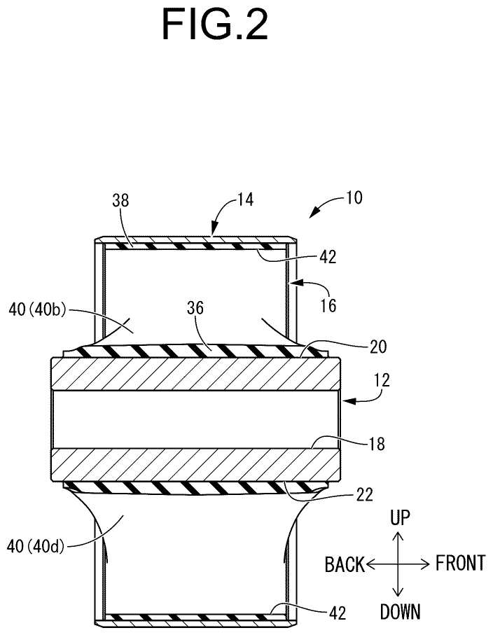

FIGS. 1 and 2 show a tubular vibration-damping device 10 for a motor mount (hereinafter referred to as “the tubular vibration-damping device 10”) as a first practical embodiment of the present disclosure. The tubular vibration-damping device 10 has a structure wherein an inner shaft member 12 and an outer tube member 14 are connected in the radial direction by a main rubber elastic body 16. In the following description, as a general rule, the up-down direction means the up-down direction in FIG. 1, the left-right direction means the left-right direction in FIG. 1, and the front-back direction means the left-right direction in FIG. 2.

As can be seen in FIG. 1, the inner shaft member 12 has a generally octagonal transverse cross-sectional shape and it extends linearly in the front-back direction with an approximately constant cross-sectional shape, as shown in FIG. 2. The inner shaft member 12 has a flat transverse cross-sectional shape elongated in the left-right direction, wherein the up-down width dimension is smaller than the left-right width dimension. The inner shaft member 12 has a circular bolt insertion hole 18 that passes through the center portion thereof in the front-back direction. The inner shaft member 12 is formed, for example, of a metal such as iron or an aluminum alloy, or a fiber-reinforced synthetic resin.

The outer peripheral surface of the inner shaft member 12, which is in a form of an octagonal prism, has an upper surface 20 and a lower surface 22 that expand in a direction substantially orthogonal to the up-down direction, a left surface 24 and a right surface 26 that expand in a direction substantially orthogonal to the left-right direction, an upper left inclined surface 28 that connects the upper surface 20 and the left surface 24, an upper right inclined surface 30 that connects the upper surface 20 and the right surface 26, a lower left inclined surface 32 that connects the lower surface 22 and the left surface 24, and a lower right inclined surface 34 that connects the lower surface 22 and the right surface 26.

The outer tube member 14 has a substantially cylindrical shape having a thin wall and a large diameter, extending linearly in the front-back direction with an almost constant circular cross section. Like the inner shaft member 12, the outer tube member 14 is formed of a metal or a fiber-reinforced synthetic resin, etc.

The inner shaft member 12 is inserted in the outer tube member 14, and the main rubber elastic body 16 is formed between the radially opposite surfaces of the inner shaft member 12 and the outer tube member 14. The main rubber elastic body 16 is integrally provided with a radially inner bonding portion 36 with a small-diameter tubular shape bonded to the outer peripheral surface of the inner shaft member 12, an outer peripheral bonding portion 38 with a large-diameter tubular shape bonded to the inner surface of the outer tube member 14, and a plurality of rubber legs 40 connecting the radially inner bonding portion 36 and the outer peripheral bonding portion 38 to each other.

The plurality of rubber legs 40 comprises four rubber legs 40a, 40b, 40c, 40d. The four rubber legs 40a-40d extend between the surfaces facing in the radial direction, i.e., the outer peripheral surface of the inner shaft member 12 and the inner surface of the outer tube member 14. The rubber legs extend diagonally, as if the rubber legs mutually separate wider apart in the circumferential direction as they go to the periphery in the up-down direction and in the left-right direction. In other words, the two rubber legs 40a and 40b extending upward from the inner shaft member 12 separate mutually in the circumferential direction as they go to the periphery, and the two rubber legs 40c and 40d extending downward separate mutually as they go to the periphery, whereby the two rubber legs 40a and 40c extend leftward, mutually separating in the circumferential direction toward the periphery, and the two rubber legs 40b and 40d extend rightward, mutually separating in the circumferential direction toward the periphery. The two rubber legs 40a and 40d are located generally opposite as they extend from the inner shaft member 12 to the upper left side and the lower right side, and the two rubber legs 40b and 40c are located generally opposite as they extend from the inner shaft member 12 to the upper right side and the lower left side.

Specifically, the rubber leg 40a extends diagonally to the upper left side from the inner shaft member 12, sloping to the left side as it moves upward, the rubber leg 40b extends diagonally to the upper right side from the inner shaft member 12, sloping to the right side as it moves upward, the rubber leg 40c extends diagonally to the lower left side from the inner shaft member 12, sloping to the left side as it moves downward, and the rubber leg 40d extends diagonally to the lower right side from the inner shaft member 12, sloping to the right side as it moves downward. Bored holes 42 are provided penetrating in the axial direction, between the four rubber legs 40a-40d in the circumferential direction. The axial end face of each rubber leg 40 is concave in the longitudinal cross section, with the radially inner portion sloping inward in the axial direction as it goes toward the periphery (toward the outer tube member 14) and the outer peripheral portion sloping outward in the axial direction as it goes toward the periphery (see FIGS. 4, 6, 8, and 10).

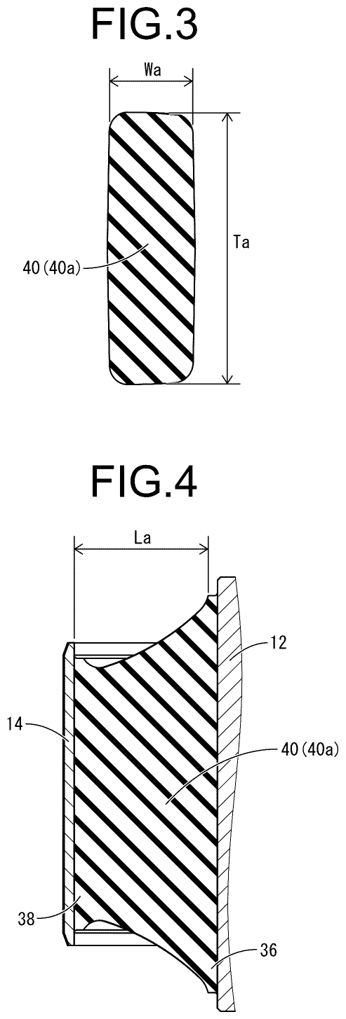

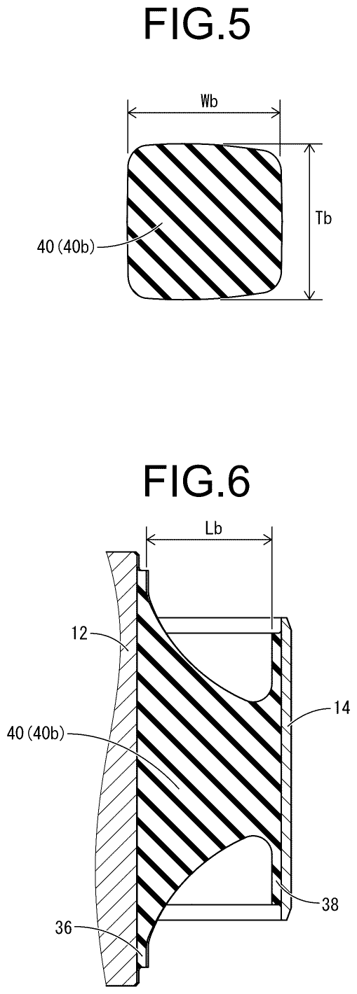

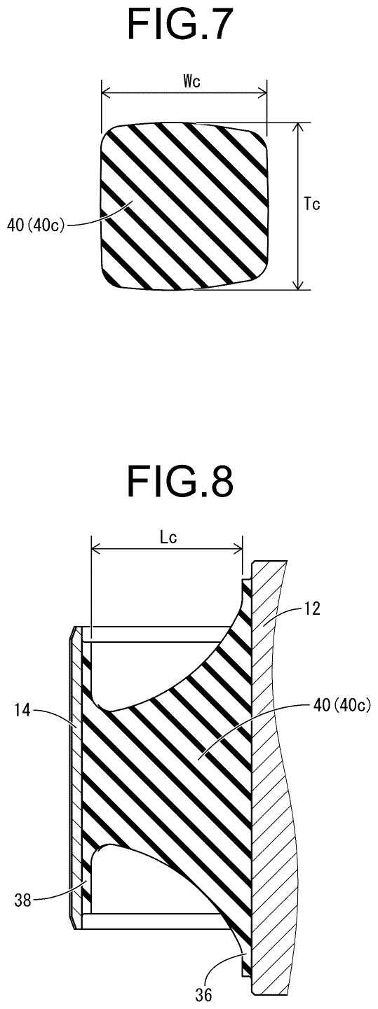

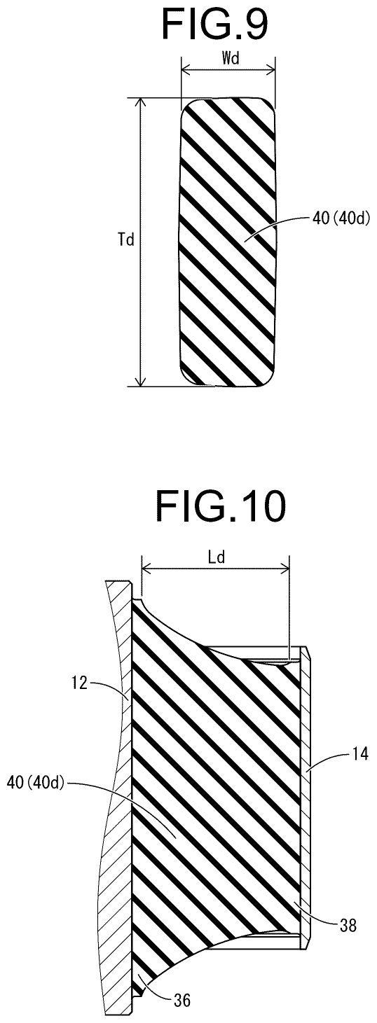

The rubber leg 40a has an axial thickness dimension Ta larger than the circumferential width dimension Wa in the leg transverse cross section of FIG. 3, and is in an approximately rectangular shape with a large oblateness in the leg transverse cross section of FIG. 3. The rubber leg 40b has an axial thickness dimension Tb substantially equal to the circumferential width dimension Wb in the leg transverse cross section of FIG. 5, and is a generally square in the leg transverse cross section of FIG. 5. The rubber leg 40c has an axial thickness dimension Tc substantially equal to the circumferential width dimension Wc in the leg transverse cross section of FIG. 7, and is a generally square in the leg transverse cross section of FIG. 7. The rubber leg 40d has an axial thickness dimension Td larger than the circumferential width dimension Wd in the leg transverse cross section of FIG. 9, and is in an approximately rectangular shape with a large oblateness in the leg transverse cross section of FIG. 9. The leg transverse cross section means a cross section orthogonal to the direction of extension (the length direction) of the rubber leg 40, and is the cross section orthogonal to the main elastic axis in the direction of extension. However, in this practical embodiment, it is a cross section approximately orthogonal to the radial line extending from the central axis of the inner shaft member 12. The leg transverse cross sections of all the rubber legs 40 in FIGS. 3, 5, 7, and 9 are leg transverse cross sections at almost the same distance from the central axis of the inner shaft member 12. As shown in FIGS. 3, 5, 7, and 9, the rubber leg 40 of this practical embodiment has an axial end face that slopes inward in the axial direction as it moves inward in the left-right direction, i.e., in the circumferential direction, so that the axial thickness dimension varies in the circumferential direction. Thus, for example, the thickness at a specific position in the circumferential direction or the average value of thickness in the circumferential direction, etc. can be adopted as the thickness dimension.

As shown in FIGS. 3 and 9, the leg transverse cross-sectional shape of the upper left rubber leg 40a and that of the lower right rubber leg 40d are mutually almost the same. Also, as shown in FIGS. 5 and 7, the leg transverse cross-sectional shape of the upper right rubber leg 40b and that of the lower left rubber leg 40c are mutually almost the same. The leg transverse cross-sectional shapes of the rubber legs 40a and 40d are different from those of the rubber legs 40b and 40c. In this practical embodiment, the ratio of the axial thickness dimension to the circumferential width dimension for the upper left rubber leg 40a and the lower right rubber leg 40d is larger than that for the upper right rubber leg 40b and the lower left rubber leg 40c.

The leg transverse cross-sectional shapes of the rubber legs 40 are considered mutually the same, not only when they are exactly the same, but also when they are similar in shape with a high conformity of shape. In the leg transverse cross section, the rubber leg 40a has a high conformity of shape to the rubber leg 40d and a low conformity of shape to the rubber legs 40b and 40c. Thus, the rubber leg 40a has the same leg transverse cross-sectional shape as that of the rubber leg 40d and a different leg transverse cross-sectional shape from those of the rubber legs 40b and 40c. As well, in the leg transverse cross section, the rubber leg 40b has a high conformity of shape to the rubber leg 40c and a low conformity of shape to the rubber legs 40a and 40d. Thus, the rubber leg 40b has the same leg transverse cross-sectional shape as that of the rubber leg 40c and a different leg transverse cross-sectional shape from those of the rubber legs 40a and 40d.

The upper left rubber leg 40a and the lower right rubber leg 40d, which have larger axial thickness dimensions, have a larger inclination angle of the axial end face of the radially inner portion in the longitudinal cross section than the upper right rubber leg 40b and the lower left rubber leg 40c, which have smaller axial thickness dimensions. Therefore, the difference between the axial thickness dimension of the upper left rubber leg 40a and the lower right rubber leg 40d and the axial thickness dimension of the upper right rubber leg 40b and the lower left rubber leg 40c gets larger toward the periphery.

The length dimension La of the upper left rubber leg 40a and the length dimension Lb of the upper right rubber leg 40b are mutually almost the same. Also, the length dimension Lc of the lower left rubber leg 40c and the length dimension Ld of the lower right rubber leg 40d are mutually almost the same. Furthermore, the length dimension La of the upper left rubber leg 40a and the length dimension Lb of the upper right rubber leg 40b are different from the length dimension Lc of the lower left rubber leg 40c and the length dimension Ld of the lower right rubber leg 40d. In this practical embodiment, the length dimension La of the upper left rubber leg 40a and the length dimension Lb of the upper right rubber leg 40b are shorter than the length dimension Lc of the lower left rubber leg 40c and the length dimension Ld of the lower right rubber leg 40d. As a result, the central axis of the inner shaft member 12 is shifted to the upper side than the central axis of the outer tube member 14. The length of the rubber leg 40 means the length in the direction of extension of the rubber leg 40, which is the direction of connection of the inner shaft member 12 and the outer tube member 14 by the rubber leg 40.

As described above, the four rubber legs 40a-40d are mutually different in at least one of cross-sectional shape and length, and they have mutually different shapes. Thus, the four rubber legs 40a-40d can exhibit mutually different spring characteristics according to their different shapes, for example, against a vibration input in the up-down direction.

For the four rubber legs 40a-40d, a difference in cross-sectional areas in the leg transverse cross section is 20% or less, e.g., in the range of 10-20%. In this practical embodiment, for the four rubber legs 40a-40d, a difference in minimum cross-sectional areas in the leg transverse cross section is 20% or less, e.g. in the range of 10-20%. This sets the four rubber legs 40a-40d without significant differences in mass from each other.

The rubber legs 40a, 40b extending upward from the inner shaft member 12 have a first common cross-sectional area part with the same cross-sectional area in the leg transverse cross section. Also, the rubber legs 40c, 40d extending downward from the inner shaft member 12 have a second common cross-sectional area part with the same cross-sectional area in the leg transverse cross section. The first common cross-sectional area part and the second common cross-sectional area part can be set at any position in the direction of extension of each rubber leg 40. However, it is desirable from the viewpoint of ease of design and the like to set them at a central position in the direction of extension of each rubber leg 40, at a certain distance from the inner shaft member 12 or the outer tube member 14 in each rubber leg 40, or at a specific position in the direction of extension of each rubber leg 40, for example.

In this practical embodiment, the difference between the length dimensions La and Lb of the upper left rubber leg 40a and the upper right rubber leg 40b and the length dimensions Lc and Ld of the lower left rubber leg 40c and the lower right rubber leg 40d is 20% or less, more suitably 15% or less. This makes the mass difference between the four rubber legs 40a-40d further smaller.

The four rubber legs 40a-40d have mutually different shapes and the difference in minimum cross-sectional areas in the leg transverse cross section is 20% or less, so that their resonant states against the vibration input in the up-down direction are mutually different. For example, the four rubber legs 40a-40d have mutually different resonance frequencies set for the vibration input in the up-down direction. In other words, the four rubber legs 40a-40d are mutually different in resonant states so that they do not resonate simultaneously at a specific frequency.

Particularly in this practical embodiment, the two upper rubber legs 40a, 40b have the first common cross-sectional area part of the same cross-sectional area, thus reducing the volume difference between those rubber legs 40a, 40b. Similarly, the two lower rubber legs 40c, 40d have the second common cross-sectional area part of the same cross-sectional area, thus reducing the volume difference between those rubber legs 40c, 40d. In this way, the volume difference, or the mass difference, between the two upper rubber legs 40a and 40b is made further smaller, whereby it becomes easier to set the resonance frequencies of those rubber legs 40a and 40b to be different from each other by the cross-sectional shape and length of those rubber legs 40a and 40b. Similarly, it is easy as well to set the resonance frequencies of the two lower rubber legs 40c and 40d to be different from each other by the cross-sectional shape and length.

In this way, the resonance frequencies of the four rubber legs 40a-40d are differentiated, so that in a vehicle-mounted state where the inner shaft member 12 is attached to the electric motor (not shown) and the outer tube member 14 is attached to the vehicle body (not shown), upon the vibration input between the inner shaft member 12 and the outer tube member 14 in the up-down direction, deterioration in resonant state due to resonance of the rubber legs 40a-40d is reduced.

The length dimensions La, Lb of the two upper rubber legs 40a, 40b are the same as each other, while the length dimensions Lc, Ld of the two lower rubber legs 40c, 40d are the same as each other, and the length dimensions La, Lb of the two upper rubber legs 40a, 40b are different from the length dimensions Lc, Ld of the two lower rubber legs 40c, 40d. As a result, the bonding portions of the rubber legs 40 in the inner shaft member 12 and the outer tube member 14 do not need to have a complicated shape, and the structure is simplified. In addition, this prevents easily-occurring load concentration on a specific rubber leg 40 upon the vibration input in the up-down direction, thus improving the durability of the rubber legs 40, for example. Especially, by making the length dimensions Lc, Ld of the lower rubber legs 40c, 40d longer than the length dimensions La, Lb of the upper rubber legs 40a, 40b, durability and lower spring are advantageously achieved against an input load that displaces the inner shaft member 12 downward relative to the outer tube member 14.

The rubber legs 40a, 40d have almost the same leg transverse cross-sectional shape, and so do the rubber legs 40b, 40c, and the rubber legs 40a, 40d have a leg transverse cross-sectional shape different from that of the rubber legs 40b, 40c. Thus, the rubber legs 40a, 40d on both sides of the inner shaft member 12 in one diagonal direction have almost the same leg transverse cross-sectional shape, and the rubber legs 40b, 40c on both sides of the inner shaft member 12 in another diagonal direction have almost the same leg transverse cross-sectional shape. This prevents unintended relative displacement, such as swinging of the inner shaft member 12 and the outer tube member 14 during an input in the up-down direction, for example, and thus stabilization of the vibration state is easily achieved.

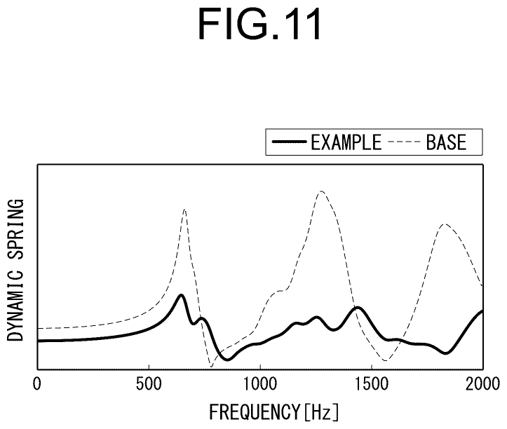

The graph of FIG. 11 showing the simulation results of the vibration-damping characteristics also indicates the fact that the tubular vibration-damping device 10 of this practical embodiment achieves excellent vibration-damping effect owing to the difference in resonance frequencies of the rubber legs 40a-40d. FIG. 11 is a graph showing the vibration-damping characteristics of the tubular vibration-damping device 10 of this practical embodiment against a vibration in the up-down direction (Example) and the vibration-damping characteristics of a tubular vibration-damping device of a conventional structure with four rubber legs of the same shape against a vibration in the up-down direction (Base), wherein the horizontal axis indicates the frequency and the vertical axis indicates the dynamic spring constant.

FIG. 11 shows that Example has a low peak of dynamic spring compared to Base, which means it has excellent vibration-damping performance. In other words, in Example, the four rubber legs 40a-40d resonate at different frequencies from each other, which prevents decline in vibration-damping performance caused by the simultaneous resonant state, and thus keeping the excellent vibration-damping performance over a wide frequency range. On the other hand, in Base, a sudden and significant increase in the dynamic spring occurs at the frequency at which some of the four rubber legs with the same shape are in a resonant state simultaneously, resulting in a significant deterioration in the vibration-damping performance.

Thus, it is clear also from the simulation results that the tubular vibration-damping device 10 of this practical embodiment exhibits superior vibration-damping performance compared to the tubular vibration-damping device of conventional construction.

Although the practical embodiment of the present disclosure has been described in detail above, the present disclosure is not limited by that specific description. For example, a stopper rubber that limits relative displacement amount of the inner shaft member and the outer tube member can be provided between adjacent rubber legs in the circumferential direction. This improves the durability of each rubber leg.

The resonance frequencies of the four rubber legs may, for example, be adjusted to be mutually different by either the leg transverse cross-sectional shape or the length. In short, the four rubber legs may be mutually the same in one of the leg transverse cross-sectional shape and the length, and mutually different in the other.

The four rubber legs have a difference of 20% or less in cross-sectional areas in the leg transverse cross section. The cross-sectional area in the leg transverse cross section here is not necessarily limited to the minimum cross-sectional area exemplified in the first practical embodiment. Alternatively, it is possible to employ the cross-sectional area at a specific position (a position with a specific distance from the inner shaft member in the length direction, a position with a specific distance from the outer tube member in the length direction, or the center in the length direction, etc.), or the average value of cross-sectional area in the length direction, etc.

The inner shaft member is not limited to the octagonal transverse cross-sectional shape as shown in the first practical embodiment, but it is possible to adopt various shapes, such as circular shapes including oval and ellipse, various polygons including rectangles, and other different shapes, for example.

All the four rubber legs may, for example, have mutually different leg transverse cross-sectional shapes, and all may have mutually different lengths.

What is claimed is:

1. A tubular vibration-damping device for a motor mount comprising:
an inner shaft member;
an outer tube member; and
a plurality of rubber legs extending between a surface of the inner shaft member and a surface of the outer tube member which face each other in a radial direction and connecting them, wherein
the plurality of rubber legs include four rubber legs which mutually separate wider apart in a circumferential direction as they go to a periphery in an up-down direction and in a left-right direction,
for the four rubber legs, a difference in cross-sectional areas each in a leg transverse cross section orthogonal to a length direction, which is a connection direction of the inner shaft member and the outer tube member, is 20% or less, and
the four rubber legs have mutually different shapes and resonant states of the four rubber legs against a vibration input in the up-down direction are mutually different.

2. The tubular vibration-damping device for the motor mount according to claim 1, wherein
two upper rubber legs of the four rubber legs have a same length dimension in the connection direction of the inner shaft member and the outer tube member,
two lower rubber legs of the four rubber legs have a same length dimension in the connection direction of the inner shaft member and the outer tube member, and
the length dimension of the two upper rubber legs in the connection direction of the inner shaft member and the outer tube member is different from that of the two lower rubber legs.

3. The tubular vibration-damping device for the motor mount according to claim 1, wherein
two upper rubber legs of the four rubber legs have a first common cross-sectional area part with a same cross-sectional area in the leg transverse cross section orthogonal to the length direction, which is the connection direction of the inner shaft member and the outer tube member, and
two lower rubber legs of the four rubber legs have a second common cross-sectional area part with a same cross-sectional area in the leg transverse cross section.

4. The tubular vibration-damping device for the motor mount according to claim 1, wherein
an upper left rubber leg and a lower right rubber leg of the four rubber legs have a same shape in the leg transverse cross section,
an upper right rubber leg and a lower left rubber leg of the four rubber legs have a same shape in the leg transverse cross section, and
the shape in the leg transverse cross section of the upper left rubber leg and the lower right rubber leg is different from that of the upper right rubber leg and the lower left rubber leg.
